(19) United States
(12) Patent Application Publication
(10) Pub. No.: US 2015/0253887 A1
(43) Pub. Date: Sep. 10, 2015

(54) INFORMATION PROCESSING APPARATUS

(71) Applicant: TOYOTA JIDOSHA KABUSHIKI KAISHA, Toyota-shi (JP)

(72) Inventor: Atsushi NISHIDA, Toyoake-shi (JP)

(21) Appl. No.: 14/592,242

(22) Filed: Jan. 8, 2015

(30) Foreign Application Priority Data
Mar. 6, 2014 (JP) 2014-044189

(51) Int. Cl. G06F 3/041

(52) U.S. Cl. CPC G06F 3/041; G06F 2203/04104

(57) ABSTRACT

An information processing apparatus includes a multipoint detectable touch panel detecting touches of a plurality of operation fingers onto an operating surface and be used for carrying out an operation on a screen page displayed on a display device, recognizes relative positional relationship of touched positions of the operation fingers for which the touch panel detects touches onto the operating surface; assigns a predetermined corresponding function to each one of the operation fingers for a case where the one of the operation fingers performs a predetermined action, based on the recognized relative positional relationship of the touched positions of the operation fingers; and executes, when the touch panel detects the predetermined action of any one of the operation fingers, the predetermined corresponding function assigned to the one of the operation fingers for a case where the one of the operation fingers performs the predetermined action.

### BACKGROUND OF THE INVENTION

1. Field of the Invention

The present invention relates to an information processing apparatus including a multipoint detectable touch panel.

2. Description of the Related Art

A technology has been disclosed where a unique function using a multi-touch action is incorporated into an information processing apparatus which has a multipoint detectable touch panel and executes a process on a display device in response to an operation input via the touch panel (for example, see Japanese Laid-Open Patent Application No. 2012-98844).

For example, Japanese Laid-Open Patent Application No. 2012-98844 discusses a technology of copying a character string by, in a state of touching one area from among a plurality of areas acquired from virtually dividing a screen page by one finger, selecting the character string by another finger. This document also discusses a technology of pasting the copied character string by performing a paste operation at a certain position in a state of touching the thus selected one area. Thus, it is possible to, in a state of touching any one of the divided areas by a finger, successively copy character strings at different places and paste these character strings at appropriate places selectively by performing copy and paste operations by another finger, through a multi-touch action.

### SUMMARY OF THE INVENTION

According to one aspect of the present invention, an information processing apparatus includes a touch panel configured to be capable of carrying out multipoint detection of detecting touches of a plurality of operation fingers onto an operating surface and be used for carrying out an operation on a screen page displayed on a display device; a recognition part configured to recognize relative positional relationship of touched positions of the operation fingers for which the touch panel detects touches onto the operating surface; an assigning part configured to assign a predetermined corresponding function to each one of the operation fingers for a case where the one of the operation fingers performs a predetermined action, based on the relative positional relationship of the touched positions of the operation fingers recognized by the recognition part; and an execution part configured to execute, when the touch panel detects the predetermined action of any one of the operation fingers, the predetermined corresponding function which is assigned by the assigning part to the one of the operation fingers for a case where the one of the operation fingers performs the predetermined action.

Other objects, features and advantages of the present invention will become more apparent from the following detailed description when read in conjunction with the accompanying drawings.

### BRIEF DESCRIPTION OF THE DRAWINGS

FIG. 1A is a block diagram illustrating one example of a configuration of an information processing apparatus according to an embodiment;

FIG. 1B illustrates a touch panel display device;

FIGS. 2A and 2B illustrate one example of a direct command mode in the information processing apparatus according to the embodiment;

FIGS. 3A and 3B illustrate another example of the direct command mode in the information processing apparatus according to the embodiment;

FIGS. 4A and 4B illustrate yet another example of the direct command mode in the information processing apparatus according to the embodiment; and

FIG. 5 is a flowchart illustrating one example of a process in the information processing apparatus (a control part) according to the embodiment.

### DETAILED DESCRIPTION OF THE EMBODIMENT

In the above-mentioned configuration of the information processing apparatus in the related art, since the user needs to view a screen page on the display device, the user may feel troublesomeness, and thus, there is room for improvement. In particular, in an information processing apparatus capable of executing very many functions, the user needs to find an element to be operated (an operating icon, an operating menus or so) by viewing the screen page, and thus, the user may bear a very large load.

In consideration of this situation, the present embodiment has an objective to provide an information processing apparatus by which, using a multipoint detectable touch panel, a user can cause the information processing apparatus to execute a desired operation without viewing a screen page on a display device.

Below, using the drawings, the embodiment of the present invention will be described.

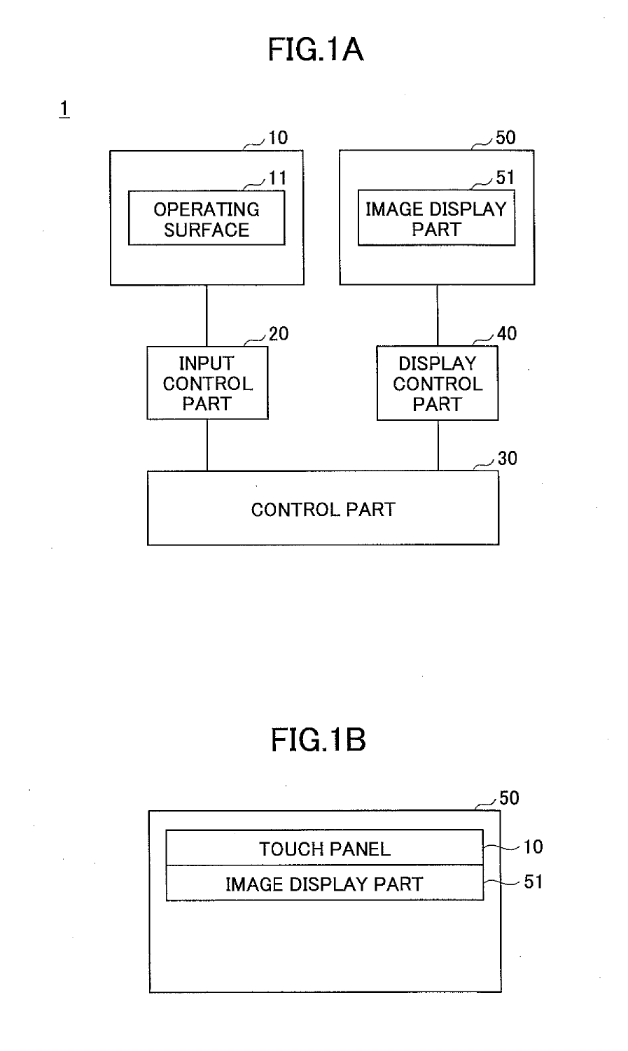

FIG. 1A is a block diagram illustrating one example of a configuration of an information processing apparatus 1 according to the embodiment. The information processing apparatus 1 can be configured to, for example, be mounted in a vehicle, receive information (signals) from on-vehicle equipment, on-vehicle various sensors and/or the like and be capable of executing a process of displaying information concerning the on-vehicle equipment, vehicle's traveling information and/or the like on a display device 50 described later. Also, the information processing apparatus 1 can be configured to be capable of executing a control process concerning a (operating) screen page displayed on the display device 50 in response to an operation input from a touch panel 10 as an operating part described later.

The information processing apparatus 1 includes the touch panel 10, an input control part 20, a control part 30, a display control part 40, the display device 50 and so forth.

The touch panel 10 is the operating part for performing an operation on the (operating) screen page displayed on the display device 50. In FIG. 1A, for the sake of convenience, the touch panel 10 is shown as being separated from the display device 50. However, actually, the touch panel 10 is placed on a surface of an image display part 51 of the display device 50, as shown in FIG. 1B. FIG. 1B illustrates a touch panel display device where the touch panel 10 is thus placed on a surface of the image display part 51. The touch panel 10 is configured to be capable of detecting a touch(s) of the operator's finger(s) (hereinafter, referred to as “operation finger(s)”) onto an operating surface 11 and outputs thus acquired detection information as an electric signal (an operation signal) to the input control part 20. Also, the touch panel 10 is a multi-touch screen capable of carrying out multipoint detection (detection of simultaneous touches of a plurality of operation fingers onto the operating surface 11). As the touch panel 10, a known system can be employed such as one of an electrostatic capacitance type, one of a resistive film type or so. Since the touch panel 10 is transparent, the user can view the displayed contents of the display device 50.

The input control part 20 is a control part that controls an operation input that is input via the operating part of the information processing apparatus 1 including the touch panel 10 and transmits the operation input that is thus input to the control part 30.

The control part 30 is a control part that controls a screen page displayed on the display device 50. For example, the control part 30 can be configured to be capable of receiving information and/or signals from the on-vehicle eluipment and/or the various on-vehicle sensors (for example, a remaining quantity meter for a fuel tank, a vehicle speed sensor and/or the like). Also, it is possible that the control part 30 executes control to display content such as information concerning the on-vehicle equipment and/or vehicle's traveling information on the display device 50. The control part 30 outputs information concerning an image (a screen page) to be displayed on the display device 50 to the display control part 40.

Further, it also possible that the control part 30 carries out control of a screen page to be displayed on the display device 50 according to an operation signal from the touch panel 10. For example, when an operation signal corresponding to an operation of tracing the operating surface 11 of the touch panel 10 in a predetermined direction (a tracing operation) is input, the control part can scroll a list within a screen page on the display device 50 or move a cursor or a pointer in a screen page. Further, when an operation signal corresponding to an operation of flicking the operating surface 11 of the touch panel 10 (a flick operation) is input, the control part 30 can scroll a screen page in the operating direction of the flick operation.

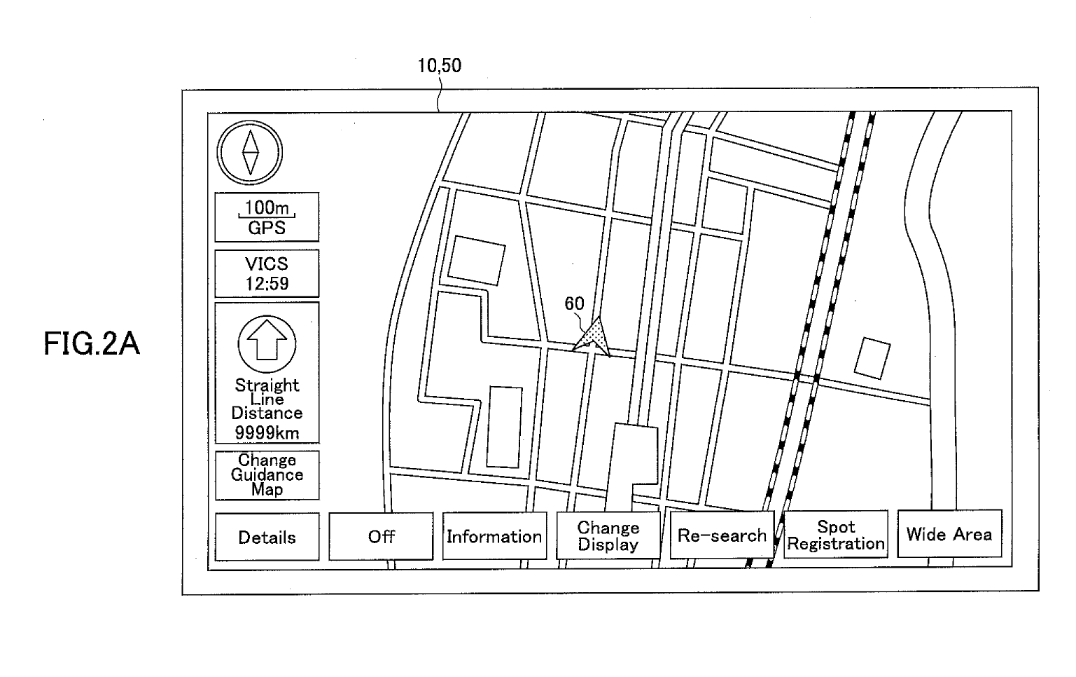

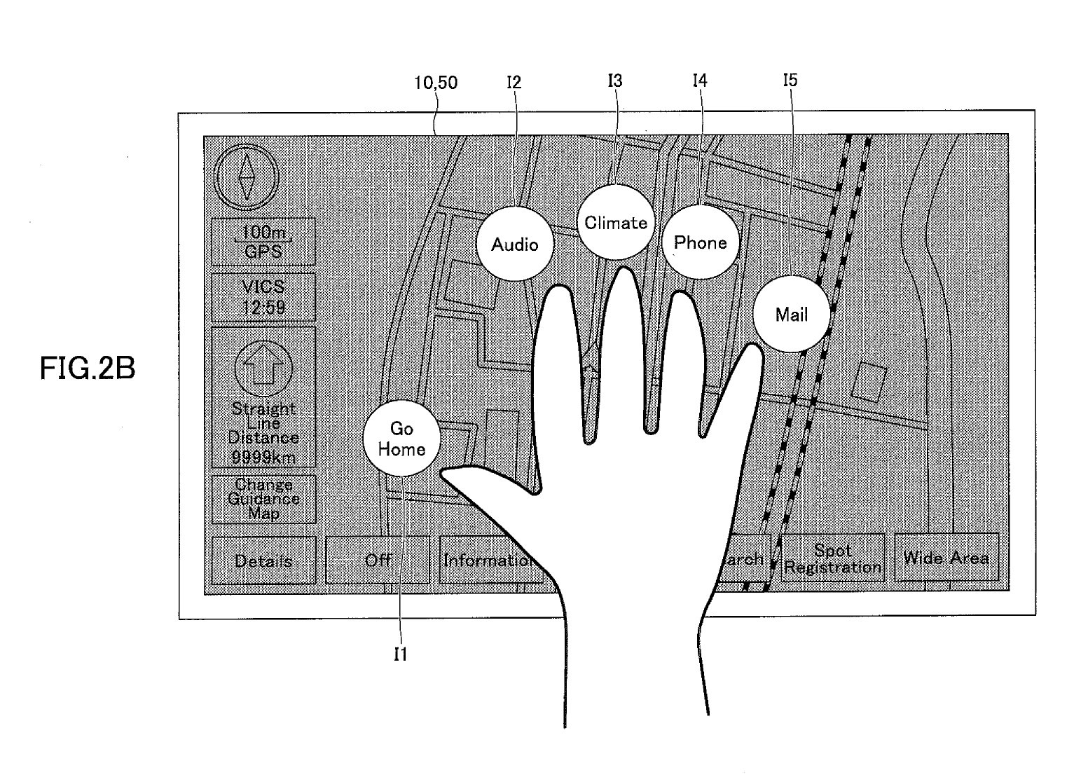

Further, it is also possible that in a predetermined case where an operation signal indicating detection of simultaneous touches of a plurality of operation fingers onto the operating surface 11 (multipoint detection) is input from the touch panel 10, the control part 30 carries out a transition to a “direct command mode” from a “normal operation mode”. Further, the control part 30 can carry out control in response to an operation signal via the touch panel 10 in the direct command mode. In the “normal operation mode”, the operator performs an operation on an screen page through the touch panel 10 by performing a touch operation of a selecting item (button, icon or so) displayed on the screen page, performing a touch operation (a fixing operation) after moving a cursor to a desired selecting item through a tracing operation, or so. In contrast thereto, in the “direct command mode”, predetermined functions are assigned to respective of operation fingers touching the operating surface 11 of the touch panel 10 regardless of the contents displayed on a screen page in the example of FIGS. 2A and 2B described later. Then, by performing a predetermined action of any one of the operation fingers, the operator can directly cause the control part 30 to carry out the function assigned to the operation finger that has thus performed the predetermined action. Note that details of the direct command mode and specific processes in response to operation signals in the direct command mode will be described later.

The display control part 40 is a control part that carries out an image generating process based on information concerning an image (a screen page) to be displayed on the display device 50 that is input from the control part 30. The display control part 40 outputs a thus generated image (screen page) signal to the display device 50.

The display device 50 is a display part that displays the above-mentioned information concerning the on-vehicle equipment, the vehicle's traveling information and/or the like. As mentioned above, the display device 50 receives an image signal corresponding to a screen page to be displayed generated by the display control part 40 and displays the screen page on the image display part 51. Thus, the driver or so can recognize the information concerning the on-vehicle equipment, the vehicle's traveling information and/or the like.

Next, distinctive processes by the information processing apparatus 1 (the control part 30) according to the present embodiment, more specifically, a process of a transition to the direct command mode and processes in response to operations in the direct command mode will be described.

FIGS. 2A and 2B illustrate one example of the direct command mode in the information processing apparatus 1 according to the embodiment. FIG. 2A shows a screen page displayed on the display device 50 in the normal operation mode, and, more specifically, a map screen page in a navigation system. FIG. 2B shows a screen page displayed on the display device 50 in the direct command mode, and more specifically, a screen page displayed on the display device 50 after the operator performs an operation for a transition to the direct command mode during the normal operation mode shown in FIG. 2A. Such an operation for a transition to the direct command mode of FIG. 2B from the normal operation mode of FIG. 2A by the operator is performed when the vehicle is stopped.

As shown in FIG. 2A, in the map screen page, an arrow 60 indicating the position of the own vehicle is displayed, and a map around the own vehicle is displayed. In the normal operation mode, the operator performs an operation through the touch panel 10 by selecting and fixing a selecting item (button, icon or so) displayed on the screen page. In FIG. 2A, virtual operating buttons (“virtual” means those other than mechanical operation buttons) are placed near the bottom and left edges of the screen page, and thus, it is possible to operate the car navigation system via the touch panel 10.

When the operator touches the operating surface 11 of the touch panel 10 in the state of FIG. 2A with the five fingers of his or her hand, the control part 30 detects the simultaneous touches of the operation fingers and carries out a transition to the direct command mode.

In the example of FIG. 2B, when the operator touches the operating surface 11 of the touch panel 10 with the five operation fingers of his or her right hand, the control part 30 carries out a transition to the direct command mode, and thus, the currently displayed map screen page is changed into a display state with reduced tone. Thereby, the operator can confirm that the control part 30 has carried out a transition to the direct command mode.

As described above, in the direct command mode, the control part 30 assigns the predetermined functions to the respective operation fingers (in this example, the five operation fingers of a right hand) touching the touch panel 10, regardless of the contents of the map screen page displayed on the screen. Then, when detecting a predetermined action (for example, a tap operation onto the operating surface 11) of any one of the operation fingers, the control part 30 executes the predetermined function assigned to the finger thus performing the predetermined action. In the example, the control part 30 displays icons indicating the functions assigned to the respective operation fingers near the coordinates on the screen of the display device 50 corresponding to the touched positions of the respective operation fingers on the operating surface 11 in an overlaying manner on the map screen page displayed with reduced tone. Specifically, at a position corresponding to the thumb on the screen of the display device 50, an icon I1 is displayed. In the icon I1, an expression “Go Home” indicating the function of showing route guidance for the home that is previously set in the navigation system is displayed. At a position corresponding to the index finger on the screen of the display device 50, an icon I2 is displayed. In the icon I2, an expression “Audio” indicating the function of changing the displayed contents to a (operating) screen page of an audio system is displayed. At a position corresponding to the middle finger on the screen of the display device 50, an icon I3 is displayed. In the icon I3, an expression “Climate” indicating the function of changing the displayed contents to a (operating) screen page of an air conditioner is displayed. At a position corresponding to the third finger on the screen of the display device 50, an icon I4 is displayed. In the icon I4, an expression “Phone” indicating the function of changing the displayed contents to a telephone calling screen page in a communication apparatus is displayed. At a position corresponding to the little finger on the screen of the display device 50, an icon I5 is displayed. In the icon I5, an expression “Mail” indicating the function of changing the displayed contents into an electronic mail screen page in the communication apparatus (i.e., a screen page for reading, producing and transmitting an electronic mail message) is displayed. By thus displaying the functions assigned to the respective operation fingers near the respective operation fingers touching the operating surface of the touch panel 10, the operator can confirm the functions assigned to the respective operation fingers and thus surely perform the operations.

In the example of FIG. 2B, as a result of, for example, the operator removing the index finger from the operating surface 11 and performing a tap operation in a state where all five operation fingers touch the operating surface 11 of the touch panel 10, the change of the displayed contents from the map screen page of the navigation system to the operating screen page of the audio system is executed.

Thus, as a result of the control part 30 assigning the predetermined functions to the respective operation fingers whose touches onto the operating surface 11 of the touch panel 10 are detected by the control part 30, the operator can cause the control part 30 to carry out the previously set corresponding function by performing the predetermined action of any one of the operation fingers without viewing the display device 50. Further, since it is possible to perform an operation to carry out the predetermined function regardless of the contents of the screen page of the display device 50, it is possible to carry out the function, originally carried out through a plurality of operations, by one operation. Thereby, it is possible to remarkably improve the operability especially concerning a function having a higher use frequency.

Although the functions are assigned to the respective operation fingers regardless of the contents of the display screen displayed on the display device 50 in the example of FIGS. 2A and 2B, it is also possible to determine (change) the functions to be assigned to the respective operation fingers depending on the contents of the display screen displayed on the display device 50.

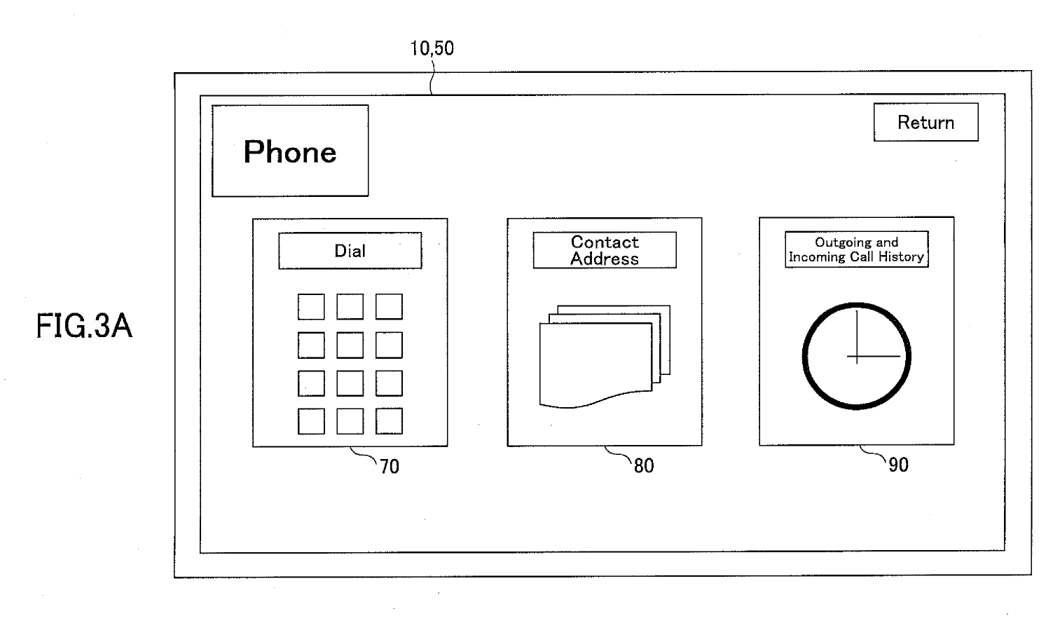

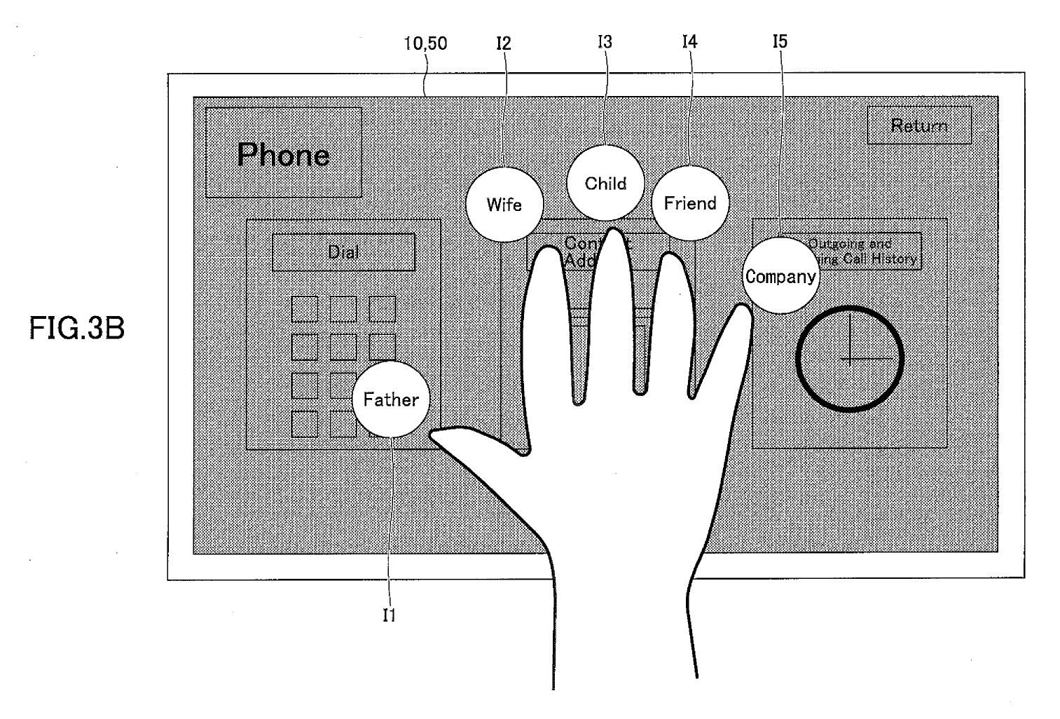

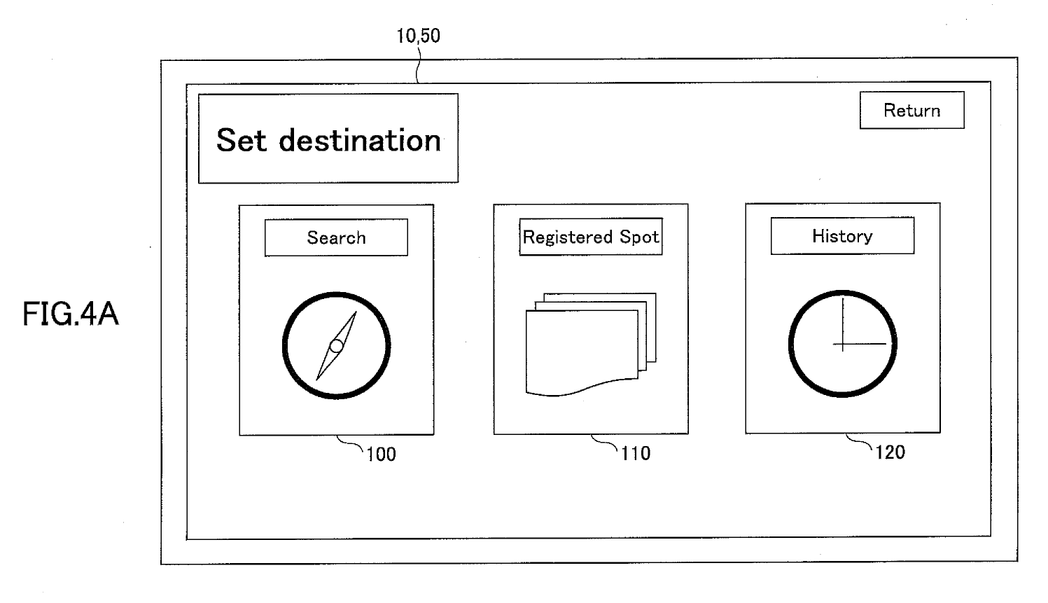

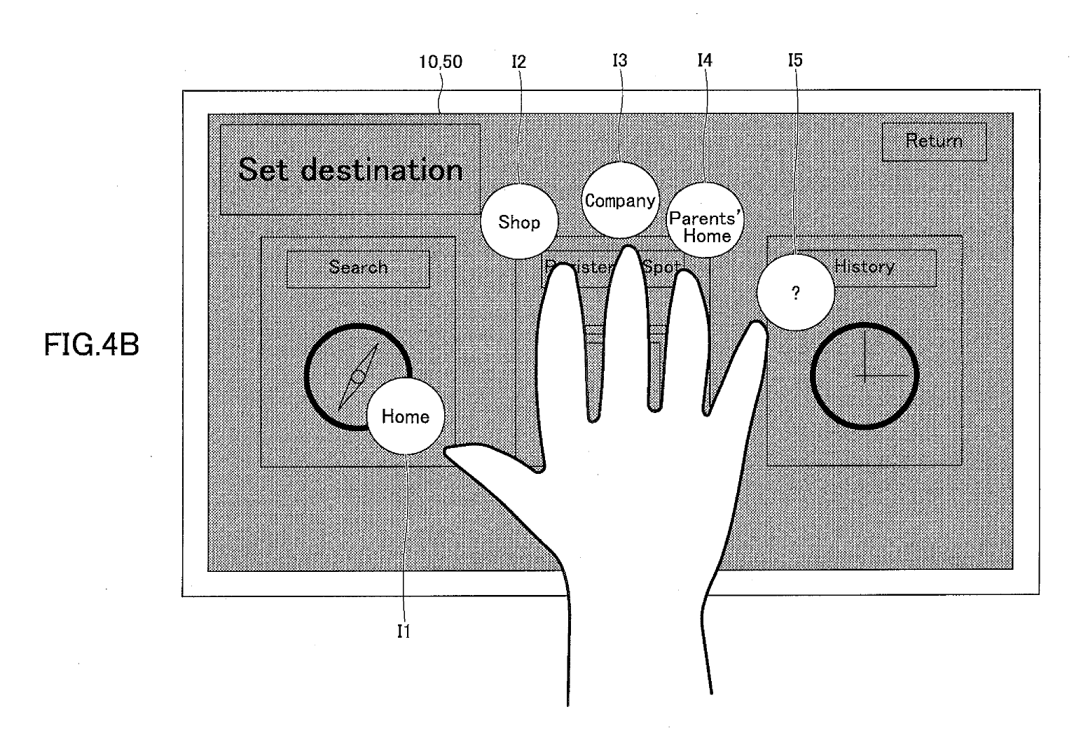

Below, using FIGS. 3A-4B, examples will be described where the functions to be assigned to the respective operation fingers are determined depending on the contents of the display screen displayed on the display device 50.

FIGS. 3A and 3B illustrate another example of the direct command mode in the information processing apparatus 1 according to the present embodiment. FIG. 3A shows a screen page displayed on the display device 50 in the normal operation mode, and more specifically, the telephone calling screen page in the communication apparatus. FIG. 3B shows a screen page displayed on the display device 50 in the direct command mode, and more specifically, a screen page displayed on the display device 50 after the operator performs an operation for a transition to the direct command mode during the normal operation mode shown in FIG. 3A. Such an operation for a transition to the direct command mode of FIG. 3B from the normal operation mode of FIG. 3A by the operator is performed when the vehicle is stopped.

As shown in FIG. 3A, in the telephone calling screen page, three selecting icons 70, 80 and 90 are displayed for identifying a calling destination. The selecting icon 70 is a selecting item for a transition to a dial screen page for directly dialing a telephone number. The selecting icon 80 is a selecting item for a transition to a contact address screen page for selecting a telephone number from among previously registered contact addresses. The selecting icon 90 is a selecting item for a transition to a calling and incoming call history screen page for selecting a telephone number of a calling destination from a past outgoing and incoming call history. The operator can call a calling destination by selecting any one of the selecting icons 70-90 via the touch panel 10 and selecting (inputting) the calling destination from the screen page displayed after the transition. Note that the operator can perform conversation with the calling designation person through a microphone and a speaker installed at predetermined positions in the vehicle interior (or a headset connected with the communication apparatus by wire or wirelessly).

When the operator touches the operating surface 11 of the touch panel 10 in the state of FIG. 3A with the five fingers of his or her hand, the control part 30 detects the simultaneous touches of the operation fingers and carries out a transition to the direct command mode.

In the example of FIG. 3B, in the same way as the example of FIG. 2B, when the operator touches the operating surface 11 of the touch panel 10 with the five operation fingers of his or her right hand, the control part 30 carries out a transition to the direct command mode, and thus, the currently displayed telephone calling screen page is changed into a display state with reduced tone.

As described above, in the direct command mode, the control part 30 assigns the predetermined functions to the operation fingers (in this example, the five operation fingers of a right hand) touching the touch panel 10. Then, when detecting a predetermined action (for example, a tap operation onto the operating surface 11) of any one of the operation fingers, the control part 30 executes the predetermined function assigned to the finger thus performing the predetermined action. In the same way as the example of FIG. 2B, the control part 30 displays icons indicating the functions assigned to the respective operation fingers near the coordinates on the screen of the display device 50 corresponding to the touched positions of the respective operation fingers on the operating surface 11 in an overlaying manner on the telephone calling screen page displayed with reduced tone.

In the example of FIG. 3B, as being different from the example of FIG. 2B, the control part 30 assigns the functions to the respective operation fingers depending on the contents displayed on the screen of the display device 50, i.e., the contents displayed on the display device 50 by the information processing apparatus 1. Specifically, in FIG. 3A, since the display device 50 is displaying the telephone calling screen page and the operator is in a state of just before selecting (inputting) the calling destination, the control part 30 assigns calling destinations previously set to the respective operation fingers as shortcut functions. As shown in FIG. 38, at a position corresponding to the thumb on the screen of the display device 50, an icon I1 is displayed. In the icon I1, an expression “Father” indicating a shortcut function for the telephone number of the father of the operator previously registered as a contact address of a telephone calling destination is displayed. At a position corresponding to the index finger on the screen of the display device 50, an icon I2 is displayed. In the icon I2, an expression “Wife” indicating a shortcut function for the telephone number of the wife of the operator previously registered as a contact address of a telephone calling destination is displayed. At a position corresponding to the middle finger on the screen of the display device 50, an icon I3 is displayed. In the icon I3, an expression “Child” indicating a shortcut function for the telephone number of the child of the operator previously registered as a contact address of a telephone calling destination is displayed. At a position corresponding to the third finger on the screen of the display device 50, an icon I4 is displayed. In the icon I4, an expression “Friend” indicating a shortcut function for a specific friend of the operator previously registered as a contact address of a telephone calling destination is displayed. At a position corresponding to the little finger on the screen of the display device 50, an icon I5 is displayed. In the icon I5, an expression “Company” indicating a shortcut function for the telephone number of the company the operator works for previously registered as a contact address of a telephone calling destination is displayed.

For example, as a result of the operator removing the middle finger from the operating surface 11 and performing a tap operation in a state where all five operation fingers touch the operating surface 11 of the touch panel 10, the shortcut function for the telephone number of the child of the operator is carried out, and calling to this telephone number is carried out.

Thus, in the same way as the example of FIG. 2B, as a result of the control part 30 assigning the predetermined functions to the respective operation fingers whose touches onto the operating surface 11 of the touch panel 10 are detected by the control part 30, the operator can cause the control part 30 to carry out the previously set corresponding function by performing the predetermined action of any one of the operation fingers without viewing the display device 50. In the example of FIG. 3B, by determining (changing) the functions to be assigned to the respective operation fingers depending on the contents of the screen page of the display device 50, it is possible to assist an operation depending on the situation. Especially when the screen page displayed on the display device 50 is a screen page for the operator to perform selection (inputting), the operator can cause the control part 30 to directly carry out a function corresponding to a desired alternative, as a result of the control 30 assigning shortcut functions corresponding to alternatives in this screen page to the respective operation fingers. Thus, it is possible to remarkably improve the operability.

Next, FIGS. 4A and 4B illustrate yet another example of the direct command mode in the information processing apparatus 1 according to the present embodiment. FIG. 4A shows a screen page displayed on the display device 50 in the normal operation mode, and more specifically, the destination setting screen page in the navigation system. FIG. 4B shows a screen page displayed on the display device 50 in the direct command mode, and more specifically, a screen page displayed on the display device 50 after the operator performs an operation for a transition to the direct command mode during the normal operation mode shown in FIG. 4A. Such an operation for a transition to the direct command mode of FIG. 4B from the normal operation mode of FIG. 4A by the operator is performed when the vehicle is stopped.

As shown in FIG. 4A, in the destination setting screen page, three selecting icons 100, 110 and 120 are displayed for identifying a destination. The selecting icon 100 is a selecting item for a transition to a destination search screen page for determining a destination by searching for the destination (for example, a search using a telephone number, an address, a keyword or so). The selecting icon 110 is a selecting item for a transition to a registered spot list screen page for selecting a destination from among previously registered spots. The selecting icon 120 is a selecting item for a transition to a destination history screen page for selecting a destination from a history of destinations for which route search was carried out. The operator can determine the destination and cause the navigation system to start route guidance by selecting any one of the selecting icons 100-120 via the touch panel 10 and selecting the destination from the screen page displayed after the transition (in a case of the destination search screen page, selecting the destination from among the search results).

When the operator touches the operating surface 11 of the touch panel 10 in the state of FIG. 4A with five fingers of his or her hand, the control part 30 detects the simultaneous touches of the operation fingers and carries out a transition to the direct command mode.

In the example of FIG. 4B, in the same way as the examples of FIGS. 2B and 3B, when the operator touches the operating surface 11 of the touch panel 10 with five operation fingers of his or her right hand, the control part 30 carries out a transition to the direct command mode, and thus, the currently displayed destination setting screen page is changed into a display state with reduced tone.

As described above, in the direct command mode, the control part 30 assigns the predetermined functions to the operation fingers (in this example, the five operation fingers of a right hand) touching the touch panel 10, respectively. Then, when detecting a predetermined action (for example, a tap operation onto the operating surface 11) of any one of the operation fingers, the control part 30 executes the predetermined function assigned to the finger thus performing the predetermined action. In the same ways as the examples of FIG. 2B and 3B, the control part 30 displays icons indicating the functions assigned to the respective operation fingers near the coordinates on the screen of the display device 50 corresponding to the touched positions of the respective operation fingers on the operating surface 11 in an overlaying manner on the destination setting screen page displayed with reduced tone.

In the example of FIG. 4B, in the same manner as the example of FIG. 3B, the control part 30 assigns the functions to the respective operation fingers depending on the contents displayed on the screen of the display device 50, i.e., the contents displayed on the display device 50 by the information processing apparatus 1. Specifically, in FIG. 4A, since the display device 50 is displaying the destination setting screen page and the operator is in a state of just before selecting (inputting) the destination for the route guidance function of the navigation system, the control part 30 assigns destinations previously set to the respective operation fingers as shortcut functions. As shown in FIG. 4B, at a position corresponding to the thumb on the screen of the display device 50, an icon I1 is displayed. In the icon I1, an expression “Home” indicating a shortcut function for the home of the operator previously registered in a registered spot list as a destination is displayed. At a position corresponding to the index finger on the screen of the display device 50, an icon I2 is displayed. In the icon I2, an expression “Shop” indicating a shortcut function for the operator's favorite store (shop) previously registered in a registered spot list as a destination is displayed. At a position corresponding to the middle finger on the screen of the display device 50, an icon I3 is displayed. In the icon I3, an expression “Company” indicating a shortcut function for the company the operator works for previously registered in a registered spot list as a destination is displayed. At a position corresponding to the third finger on the screen of the display device 50, an icon I4 is displayed. In the icon I4, an expression “Parents' home” indicating a shortcut function for the parents' home of the operator previously registered in a registered spot list as a destination is displayed. Further, in the example of FIG. 4B, since no shortcut function is correspondingly assigned to the little finger, an expression “?” indicating that nothing is set is displayed at a position corresponding to the little finger. When assigning of a shortcut function is correspondingly set to the little finger as the operation finger, a corresponding expression is displayed in the icon I5 indicating the shortcut function corresponding to the assigning that is thus set, accordingly.

For example, as a result of the operator removing the third finger from the operating surface 11 and performing a tap operation in a state where all five operation fingers touch the operating surface 11 of the touch panel 10, the shortcut function for the parents' home of the operator registered in the register spot list as a destination is carried out, and route search from the present place to the operator's parents' home and corresponding route guidance are carried out.

Thus, in the same way as the examples of FIGS. 2B and 3B, as a result of the control part 30 assigning the predetermined functions to the respective operation fingers whose touches onto the operating surface 11 of the touch panel 10 are detected by the control part 30, the operator can cause the control part 30 to carry out the previously set corresponding function by performing the predetermined action of any one of the operation fingers without viewing the display device 50. In the same way as the example of FIG. 3B, by determining (changing) the functions to be assigned to the respective operation fingers depending on the contents of the screen page of the display device 50, it is possible to assist operations depending on the situation. Especially when the screen page displayed on the display device 50 is a screen page for the operator to perform selection (inputting), the operator can cause the control part 30 to directly carry out a function corresponding to a desired alternative, as a result of the control part 30 assigning shortcut functions corresponding to alternatives in this screen page to the respective operation fingers. Thus, it is possible to remarkably improve the operability.

In the examples shown in FIGS. 2A-4B, it is preferable that, as the functions that the control part 30 assigns to the respective operation fingers, those assumed to be frequently used by the operator are set. Also, it is preferable that the operator can set and/or change, via a setting screen page or so, the functions that the control part 30 assigns to the respective operation fingers, according to his or her predilection or use frequency. Further, in the examples, operations in the direct command mode using a right hand have been described. However, it is also possible that the control part 30 is configured so that operations using a left hand are also possible, or it is also possible that the control part 30 is configured so that operations in the direct command mode are possible as a result of operation fingers of both hands touching the screen page 11. Further, it is possible that the control part 30 previously stores, in an internal memory, information for determining the relative positional relationship of the respective fingers of the human being based on statistical data or so and associates the detection points included in the operation signal from the touch panel 10 with the respective fingers of the human being based on the stored information. Further, as the predetermined action of the operation fingers in the direct command mode, any operation can be previously set, other than the above-mentioned tap operation, such as an operation of removing a finger, a double tap operation of performing two tap operations during a predetermined time, or so.

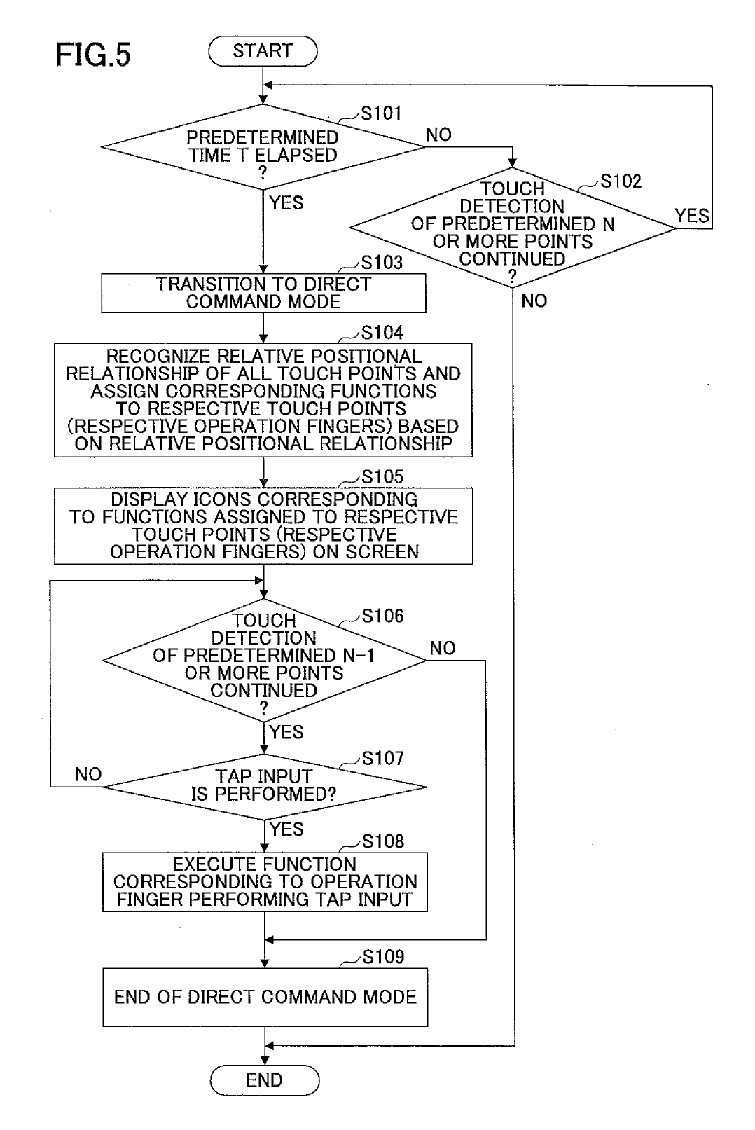

Details of a process of a transition to the direct command mode by the information processing apparatus 1 (control part 30) and a process in response to an operation in the direct command mode will be described using FIG. 5.

FIG. 5 is a flowchart illustrating one example of a process in the information processing apparatus 1 (control part 30) according to the present embodiment. Specifically, FIG. 5 is a flowchart illustrating one example of a process starting from a transition to the direct command mode and including an operation in response to an operation input in the direct command mode. This process flow can be executed each time the touch panel 10 detects a predetermined number N (5, for example, when predetermined functions are assigned to the five fingers of a hand) or more of touched points (i.e., points at which the operation fingers touch).

As shown in FIG. 5, in Step S101, the control part 30 determines whether a predetermined time T has elapsed during which touches of the predetermined N points or more of the operation fingers have been continuously detected. When the predetermined time T has elapsed, the control part 30 proceeds to Step S103. When the predetermined time T has not elapsed yet, the control part 30 proceeds to Step S102.

In Step S102, the control part 30 determines whether the touches of the predetermined N points or more of the operation fingers have been continuously detected. When they have been continuously detected, the control part 30 returns to Step S101. When they have not been continuously detected, the control part 30 finishes the current process.

In Step S103, the control part 30 changes the operation mode using the touch panel 10 from the normal operation mode to the direct command mode in response to the fact that the touches of the predetermined N points or more of the operation fingers have been continuously detected for the predetermined time T. As a result, it is possible that a transition to the direct command is carried out only when the operator touches the touch panel 10 by the plurality of fingers intentionally. Thus, it is possible to avoid a transition to the direct command mode through an erroneous operation such as a case of touching by accident.

In Step S104, based on the operation signal that is input from the touch panel 10, the control part 30 recognizes the relative positional relationship of all the detected touched points. Then, based on the relative positional relationship, the control part 30 assigns the functions to the respective touched points (i.e., the respective operation fingers). For example, as described above, the control part 30 can previously store, in an internal memory, information for determining the relative positional relationship of the respective fingers of the human being based on statistical data or so and associate the detection points included in the operation signal from the touch panel 10 with the respective fingers of the human being based on the stored information. Then, the control part 30 assigns the predetermined functions that are previously set to the predetermined operation fingers thus associated with the respective touched points. At this time, it is possible to assign the predetermined functions to the respective operation fingers regardless of the contents of the screen page of the display device 50 as in the example of FIGS. 2A-2B. It is also possible that the predetermined functions to be assigned to the respective operation fingers are determined (changed) depending on the contents of the screen page of the display device 50.

In Step S105, the control part 30 displays the icons corresponding to the functions thus assigned to (the respective operation fingers thus associated with) the respective touched points. As in the above-mentioned examples, each icon is displayed within a predetermined area from the coordinate position on the screen of the display device 50 of the corresponding touched point (touched position of the corresponding operation finger) (more preferably, near and above the coordinate position so that the icon is prevented from being hidden by the operator's palm covering the operating surface 11). Thus, it is possible that the operator can confirm the functions associated with the respective operation fingers, and thus, surely perform operation.

In Step S106, the control part 30 determines whether the touches of the predetermined N−1 points or more of the operation fingers have been continuously detected. When they have been continuously detected, the control part 30 proceeds to Step S107. When they have not been continuously detected, the control part 30 proceeds to Step S109. In Step S106, the control part 30 determines whether, in a state of waiting for the operator's subsequent operation in the direct command mode, the touched points on the operating surface 11 of the touch panel 10 detected at the time of starting this flow are still being detected. If, in a state of waiting for the operator's subsequent operation in the direct command mode, these touched points become not to be detected, the control part 30 finishes the direct command mode (in Step S109 described later). The reason why the control part 30 determines whether the touches of the predetermined N−1 points (less than the predetermined number N by 1) or more of the operation fingers have been continuously detected in Step S106 is that, since the corresponding operation finger is removed from the operating surface 11 of the touch panel 10 at a time of a tap operation, it is necessary to prevent the direct command mode from being finished thereby.

In Step S107, the control part determines whether the operation signal corresponding to a tap operation (the predetermined action) of any one from among the operation fingers whose touches onto the operating surface 11 of the touch panel 10 have been detected is input. When the operation signal corresponding to the tap operation is input, the control part 30 proceeds to Step S108. When the operation signal corresponding to the tap operation is not input, the control part 30 returns to Step S106.

In Step S108, the control part 30 executes the corresponding function assigned to the operation finger that has performed the tap operation, based on the operation signal that has been thus input from the touch panel 10.

In Step S109, the control part 30 finishes the direct command mode, carries out a transition to the normal operation mode and finishes the current process.

Note that, in consideration that operation is performed by any finger of both hands of an operator, the predetermined number N can be set appropriately to any number in the range of 2≦N≦10.

According to the present embodiment thus described above, it is possible to provide an information processing apparatus by which, using a multipoint detectable touch panel, a user can cause the information processing apparatus to execute a desired operation without viewing a screen page on a display device.

Thus, the information processing apparatus has been described by the embodiment. However, the present invention is not limited to the specific embodiment, and variations, modifications and/or replacements can be made on the embodiments without departing from the scope of the present invention claimed.

For example, in the above-described embodiment, the touch panel 10 is placed on the surface of the image display part 51 of the display device 50. However, it is also possible that the touch panel 10 is placed remotely separated from the display device 50. Also in this case, the information processing apparatus 1 provides the same advantageous effects as those of the above-described embodiment. That is, for example, the operator can cause the control part 30 to carry out the functions assigned to the respective operation fingers without viewing the screen by touching his or her operation fingers onto the touch panel (touch pad) placed at hand and performing the predetermined action of any one of these operation fingers.

In the above-described embodiment, the information processing apparatus 1 is an on-vehicle apparatus. However, another embodiment of the present invention can be an information processing apparatus which is not mounted in a vehicle. That is, the process of a transition to the direct command mode and processes carried out in response to operations in the direct command mode described above for the embodiment can also be applied to any information processing apparatus carrying out a process in response to an operation preformed on a screen page using a touch panel, regardless of whether the information processing apparatus is mounted in a vehicle.

The present application is based on and claims the benefit of priority of Japanese Priority Application No. 2014-044189, filed on Mar. 6, 2014, the entire contents of which are hereby incorporated herein by reference.

What is claimed is:

1. An information processing apparatus comprising:
a touch panel configured to be capable of multipoint detection of detecting touches of a plurality of operation fingers onto an operating surface and be used for carrying out an operation on a screen page displayed on a display device;
a recognition part configured to recognize relative positional relationship of touched positions of the operation fingers for which the touch panel detects touches onto the operating surface;
an assigning part configured to assign a predetermined corresponding function to each one of the operation fingers for a case where the one of the operation fingers performs a predetermined action, based on the relative positional relationship of the touched positions of the operation fingers recognized by the recognition part; and
an execution part configured to execute, when the touch panel detects the predetermined action of any one of the operation fingers, the predetermined corresponding function which is assigned by the assigning part to the one of the operation fingers for a case where the one of the operation fingers performs the predetermined action.

2. The information processing apparatus as claimed in claim 1, wherein
the assigning part is configured to assign the predetermined corresponding function to each one of the operation fingers for which the touch panel detects touches onto the operating surface continuously for a predetermined time.

3. The information processing apparatus as claimed in claim 1, wherein
the execution part is configured to display, within a predetermined area from a coordinate position of the touched position on the screen of the display device corresponding to each one of the operation fingers for which the touch panel detects touches onto the operating surface, an icon corresponding to the predetermined corresponding function assigned by the assigning part to the one of the operation fingers.

4. The information processing apparatus as claimed in claim 2, wherein
the execution part is configured to display, within a predetermined area from a coordinate position of the touched position on the screen of the display device corresponding to each one of the operation fingers for which the touch panel detects touches onto the operating surface, an icon corresponding to the predetermined corresponding function assigned by the assigning part to the one of the operation fingers.

5. The information processing apparatus as claimed in claim 1, wherein
the assigning part is configured to change the predetermined corresponding function to be assigned to each one of the operation fingers depending on the screen page displayed on the display device.

6. The information processing apparatus as claimed in claim 2, wherein
the assigning part is configured to change the predetermined corresponding function to be assigned to each one of the operation fingers depending on the screen page displayed on the display device.

7. The information processing apparatus as claimed in claim 3, wherein
the assigning part is configured to change the predetermined corresponding function to be assigned to each one of the operation fingers depending on the screen page displayed on the display device.

8. The information processing apparatus as claimed in claim 4, wherein
the assigning part is configured to change the predetermined corresponding function to be assigned to each one of the operation fingers depending on the screen page displayed on the display device.

9. The information processing apparatus as claimed in claim 1, wherein
the display device is configured to be a touch panel display device where the touch panel is placed on a surface of an image display part.

10. The information processing apparatus as claimed in claim 2, wherein
the display device is configured to be a touch panel display device where the touch panel is placed on a surface of an image display part.

11. The information processing apparatus as claimed in claim 3, wherein
the display device is configured to be a touch panel display device where the touch panel is placed on a surface of an image display part.

12. The information processing apparatus as claimed in claim 4, wherein
the display device is configured to be a touch panel display device where the touch panel is placed on a surface of an image display part.

13. The information processing apparatus as claimed in claim 5, wherein
the display device is configured to be a touch panel display device where the touch panel is placed on a surface of an image display part.

14. The information processing apparatus as claimed in claim 6, wherein
the display device is configured to be a touch panel display device where the touch panel is placed on a surface of an image display part.

15. The information processing apparatus as claimed in claim 7, wherein
the display device is configured to be a touch panel display device where the touch panel is placed on a surface of an image display part.

16. The information processing apparatus as claimed in claim 8, wherein
the display device is configured to be a touch panel display device where the touch panel is placed on a surface of an image display part.
